(19) United States
(12) Patent Application Publication
(10) Pub. No.: US 2010/0199118 A1
(43) Pub. Date: Aug. 5, 2010

(54) MICROCONTROLLER WITH COMPATIBILITY MODE

(75) Inventor: Benjamin Francis Froemming, San Jose, CA (US)

Correspondence Address: FISH & RICHARDSON P.C., PO BOX 1022, MINNEAPOLIS, MN, 55440-1022, US

(73) Assignee: ATMEL Corporation, San Jose, CA (US)

(21) Appl. No.: 12/364,960

(22) Filed: Feb. 3, 2009

(51) Int. Cl. G06F 9/318; G06F 1/04

(52) U.S. Cl. 713/500; 712/229; 712/E09.035

(57) ABSTRACT

A microcontroller is operable to enable a compatibility mode where a clock source of the microcontroller is adjusted to support timing requirements of applications written for legacy microcontrollers. In some implementations, one or more scaling factors and/or wait state factors are applied to the clock source of the microcontroller to ensure timing compatibility.

### TECHNICAL FIELD

This subject matter is generally related to legacy software compatibility with new generation microcontroller hardware.

### BACKGROUND

Many applications employing embedded microcontrollers, such as automobile controllers, industrial equipment, and telecommunications equipment, have longer product life cycles than typical consumer products. The software that the automobile, manufacturing, and telecommunications industries develop for the embedded microcontrollers, for example, may be in use for decades. When a microcontroller manufacturer releases a next generation version of a microcontroller, the software developed for the previous generation of microcontroller may behave differently when run on the new model. For example, although the same instruction set is used to program both the previous and next generation microcontrollers, the timing behavior of the executed software may differ.

In one example, a large body of legacy software and systems relies upon the MCS-51™ instruction set (available through Intel Corporation of Santa Clara, Calif.). Several microcontroller manufacturers have increased the performance of 8051-based microcontroller devices by optimizing the instruction execution while maintaining software binary compatibility with previous devices. When replacing a multiple cycle 8051-based microcontroller (e.g., the AT89C2051 available from Atmel Corporation of San Jose, Calif.) with a reduced-cycle 8051 microcontroller (e.g., the AT89LP2052 available from Atmel Corporation of San Jose, Calif.), for example, a legacy software program may execute six to twelve times faster than it had on the multiple-cycle version. For many applications this speed up is beneficial, but critical delay loops within the software code may need to be re-timed to provide accurate timing to the product. In some cases this retiming is not possible if the development stage for the product is completed, or the design has been in production for some time. Additionally, microcontroller vendors want to market their latest products and not obsolete old ones, while their customers want to replace older devices with new ones and have their existing applications work without making changes. This problem is further compounded because many applications employing legacy processors (e.g., 8051 processors), such as industrial equipment and telecommunications applications, have longer product life cycles than standard consumer products.

One method of creating compatibility between microcontrollers with timing incompatibilities is to use duplicate control stores (e.g., ROM, PLA, random gates), one for compatibility mode and one for a fast mode, and switch between the two modes. This technique, however, can result in a large area overhead and possible reduction in performance.

### SUMMARY

A microcontroller is operable to enable a compatibility mode where a clock source of the microcontroller is adjusted to support timing requirements of applications written for legacy microcontrollers. In some implementations, one or more scaling factors and/or wait state factors are applied to the clock source of the microcontroller to ensure timing compatibility. The microcontroller with compatibility mode allows a reduced-cycle microcontroller to operate in a manner similar to a multi-cycle version of the same microcontroller, with regard to instruction execution timing. For example, the compatibility mode allows a fast single-cycle microcontroller to act like a slower multi-cycle microcontroller, in regards to drop-in software timing compatibility.

### DESCRIPTION OF DRAWINGS

FIG. 1 is a block diagram of an example microcontroller with a selectable timing adjustment module.

FIG. 2 is a timing diagram for an example set of instructions executed upon a multiple-cycle microcontroller.

FIG. 3 is a timing diagram for an example set of instructions executed upon a reduced-cycle microcontroller.

FIG. 4 is a block diagram of an example clock control for use within the selectable timing adjustment module of FIG. 1.

FIG. 5 is a table of example timing translations for instructions performed upon a reduced-cycle microcontroller versus a multiple-cycle microcontroller.

FIG. 6 is a timing diagram for an example set of instructions executed upon a reduced-cycle microcontroller operating within a multiple-cycle compatibility mode.

FIG. 7 is a flow diagram of an example microcontroller-implemented process for modifying instruction execution time.

FIG. 8 is a timing diagram for the example clock control unit of FIG. 4.

### DETAILED DESCRIPTION

### System Overview

As used herein, a multi-cycle microcontroller is any microcontroller that requires multiple clock cycles to execute an instruction. A reduced-cycle microcontroller is any microcontroller that executes the same instructions set as the multi-cycle microcontroller, but uses fewer clock cycles per instruction. The multi-cycle microcontroller is also referred to as a compatibility mode of the microcontroller and the reduced-cycle microcontroller is referred to as a fast mode of the microcontroller.

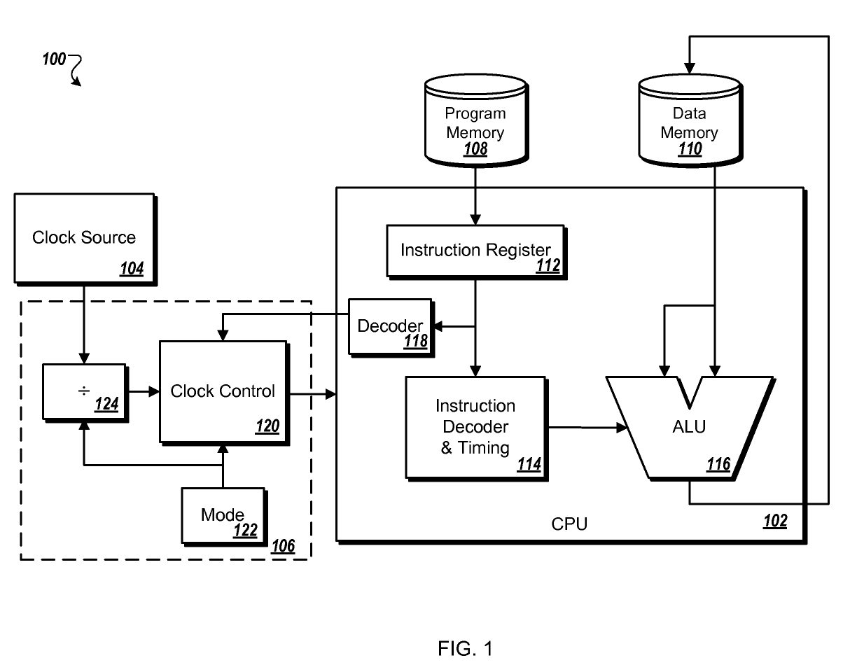

FIG. 1 is a block diagram of an example microcontroller 100 with a selectable timing adjustment module 106 which, when enabled, makes adjustments to a clock source 104 being input to a central processing unit 102, allowing the microcontroller 100 to support the timing of a previous generation microcontroller device. The microcontroller 100, for example, can be used to execute legacy software upon a newer version of microcontroller device without altering the timing behavior of the executed instructions. In some implementations, the timing adjustment module 106 can be added to a microcontroller device as additional hardware, a hardware description language (HDL) programmable soft logic core unit, and/or an integrated portion of the hardware of the microcontroller 100.

In some implementations, the microcontroller 100 contains circuitry within the CPU 102 such as an instruction register 112, an instruction decoder and timing unit 114, and an arithmetic logic unit (ALU) 116. The microcontroller 100 further includes a program memory 108 and a data memory 110. Input from the clock source 104 drives the CPU 102. The instruction register 112 retrieves instructions from the program memory 108. The instruction decoder and timing unit 114 provides instruction timing for the ALU 116 to process data (e.g., from/to the data memory 110) according to the current instruction in the instruction register 112.

Within the timing adjustment module 106, a mode input 122 selects between operating at the current generation processing speed (e.g., a reduced-cycle microcontroller) or at the previous generation processing speed (e.g., a multiple-cycle microcontroller). In some examples, the mode input 122 may be implemented as an instruction setting, firmware-programmable option, package pin, register bit, or hardware fuse. In some implementations, the mode input 122, rather than being a binary input, may select from multiple modes. For example, the timing adjustment module 106 can be used in a fast, reduced-cycle mode, a multiple-cycle mode, or a transition mode (e.g., a different microcontroller model/manufacturer).

When the mode input 122 is activated, a clock divider 124 divides the clock source 104. For example, an instruction retrieved from the instruction register 112 may initially be scaled by a set value. Each instruction, as run within the multiple-cycle microcontroller, may have taken at least six clock cycles to perform, while the fastest instruction within the reduced-cycle microcontroller executes within a single clock cycle. In this manner, a scaling factor of six can be applied (e.g., the clock may be divided by six).

The following example equation can be used to represent the translation between the clock cycles required for the multiple-cycle microcontroller versus the reduced-cycle microcontroller:

T₂(I)=T(I)*S(I)+W(I), (1)

where I is the present instruction, S(I) is a scale factor between the reduced-cycle microcontroller and the multiple-cycle microcontroller, W(I) is a wait cycle associated with the instruction I as executed within the multiple-cycle microcontroller, T₁(I) is a first execution time of instruction I in accordance with a first mode, and T₂(I) is a second execution time of instruction I in accordance with a second or compatibility mode of the microcontroller.

In some implementations, the clock divider 124 can provide a portion of the S(I) scaling factor, while a clock control unit 120 determines the W(I) wait cycle timing adjustment based upon instruction information received from a decoder 118. In some implementations, the clock divider 124 and the clock control unit 120 are implemented as a single element (e.g., hardware, firmware, etc.).

The clock control unit 120, in some implementations, can be implemented as a finite state machine (FSM) which adjusts the input clock source 104 to expand the clock timing of the present instruction I such that the instruction I executes at the same timing as when executed upon a multiple-cycle microcontroller. The decoder 118 decodes instruction information from the instruction register 112 and provides it to the clock control unit 120. When the instruction decoder and timing unit 114 schedule a particular instruction I, if the mode input 122 is activated (e.g., multiple-cycle microcontroller mode is selected), the ALU 116 executes the instruction I at the pace of the modified clock input provided to the CPU 102 by the clock control unit 120.

In some implementations, additional terms may be factored out of equation (1). For example, because the scale factor S(I) may be dependent upon the current instruction I, a divider adjustment D may be factored out. The divider adjustment D may represent the quantity adjustment provided by the clock divider 124. The wait state W(I) may also be factored, for example, into A(I) representing the number of wait states, each wait state scaled by a wait scaling factor B(I) and/or the divider adjustment D. One or more further adjustments (e.g., C(I), etc.) may be included to produce the following example equation:

T₂(I)=((T₁(I)+A(I))*B(I)+C(I))*D. (2)

In some implementations, the scaling factors A(I), B(I), and C(I) are all dependent upon the current fetched instruction I. In other implementations, one or more of the scaling factors A(I), B(I), and C(I) may represent a constant value. For example, the scaling factor B or D can be set to a constant value of one. In another example, the scaling factor A or C may always be zero. Other equations are possible.

### Multiple-Cycle Microcontroller

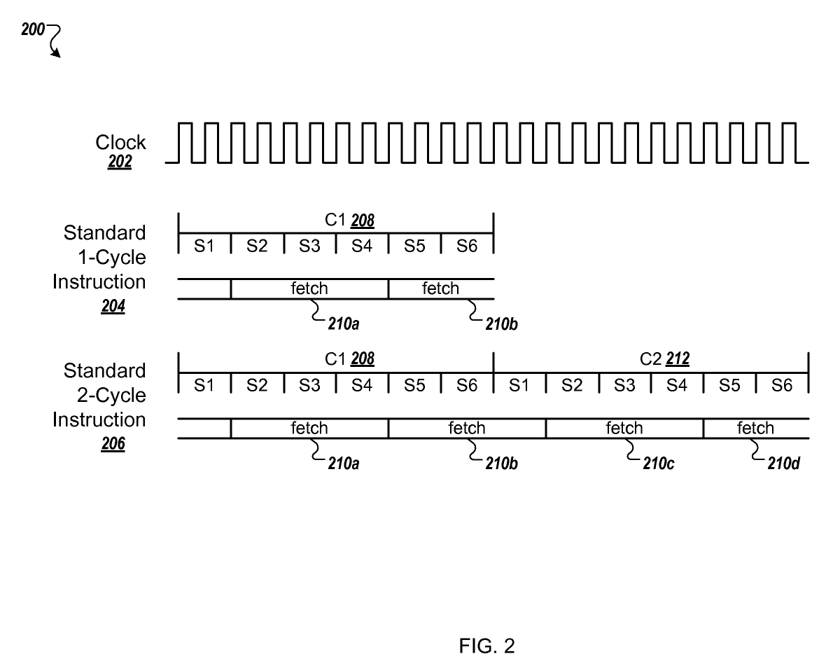

FIG. 2 is a timing diagram for an example set of instructions executed upon a multiple-cycle microcontroller. The multiple-cycle microcontroller, in this example, is a six-state cycle microcontroller device such as the classic 8051 microcontroller manufactured by Intel Corporation of Santa Clara, Calif. Each instruction cycle contains two instruction byte fetch sequences, each executed within the span of three clock states. Instructions may execute in one, two, or four instruction cycles, equating to six, twelve, or twenty-four clock states. The external clock source is divided by two to create the internal system clock so that each CPU clock state lasts two external clock cycles. Therefore, each instruction lasts for 12, 24, or 48 external clock cycles.

The timing diagram 200 includes an external clock signal 202, a 1-cycle instruction 204, and a 2-cycle instruction 206. During the first twelve clock cycles of the external clock signal 202, a first instruction cycle 208 (C1) spans six internal clock states (e.g., S1, S2, S3, S4, S5, and S6). The first instruction cycle 208 contains two instruction byte fetch sequences 210a and 210b. The first byte fetch sequence 210a begins during the second internal clock state S2 of the first instruction cycle 208. The second byte fetch sequence 210b does not reach completion during the first instruction cycle 208. Although the second byte fetch sequence 210b is illustrated within the 1-cycle instruction 204, the second byte fetch sequence 210b is not necessary to the 1-cycle instruction 204. The machine cycle design of the multiple-cycle microcontroller is based upon an even number of instruction byte fetches. For instruction cycles involving an odd number of fetches, additional unnecessary fetches may be included within the sequence.

Referring to the 2-cycle instruction 206, during the second twelve clock cycles of the external clock signal 202, a second instruction cycle 212 (C2) spans six internal clock states. The second byte fetch sequence 210b concludes during the first internal clock state S1 of the second instruction cycle 212. The second instruction cycle 212 further includes a third byte fetch sequence 210c and a fourth byte fetch sequence 210d, which does not reach completion during the second instruction cycle 212.

### Reduced-Cycle Microcontroller

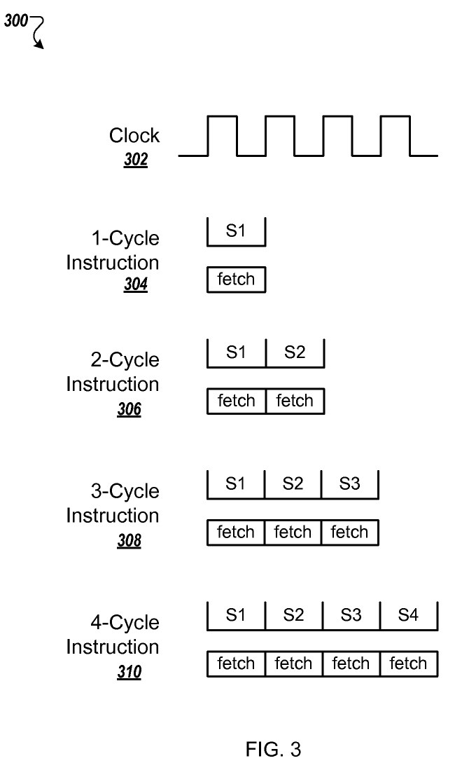

FIG. 3 is a timing diagram for an example set of instructions executed upon a reduced-cycle microcontroller. The reduced-cycle microcontroller uses clock cycles rather than machine cycles for instruction fetches. Instructions may be executed in one, two, three, or four clock cycles. The timing diagram 300 includes an external clock signal 302, a 1-cycle instruction 304, a 2-cycle instruction 306, a 3-cycle instruction 308, and a 4-cycle instruction 310. The internal clocking of the reduced-cycle microcontroller, in this example, may be considered to be synchronous to the external clock signal 302.

The 1-cycle instruction 304 includes a single instruction byte fetch, executed within a single clock state S1. The clock state S1 spans a single cycle of the external clock 302. In other implementations, a 1-cycle instruction may be executed within multiple clock states rather than one (e.g., two). The 1-cycle instruction 304 is six times faster than the 1-cycle instruction 204 of the multiple-cycle microcontroller (as shown in FIG. 2) in terms of internal clock states, and the 1-cycle instruction 304 is twelve times faster than the 1-cycle instruction 204 in terms of external clock states.

The 2-cycle instruction 306 includes two instruction byte fetches, each fetch executed within a single clock state (S1, S2). The 2-cycle instruction 306 executes within two cycles of the external clock 302.

The 3-cycle instruction 308 includes three instruction byte fetches, each fetch executed within a single clock state (S1, S2, S3). The 3e-cycle instruction 308 executes within three cycles of the external clock 302.

The 4-cycle instruction 310 includes four instruction byte fetches, each fetch executed within a single clock state (S1, S2, S3, S4). The 4-cycle instruction 310 executes within four cycles of the external clock 302.

Software designed for the multiple-cycle microcontroller as illustrated in FIG. 2 may execute with a different timing behavior when run on the reduced-cycle microcontroller as illustrated in FIG. 3. If the legacy software application is timing dependent, upgrading from the multiple-cycle microcontroller to the reduced-cycle microcontroller may have undesirable results. If the manufacturer of the previous generation multiple-cycle microcontroller discontinued the multiple-cycle microcontroller product, the legacy software application may not perform adequately to be used. Instead of modifying or rewriting the legacy software, the clock source of the reduced-cycle microcontroller can be adjusted to support the instruction timing of the multiple-cycle microcontroller.

### Example Clock Control Circuit

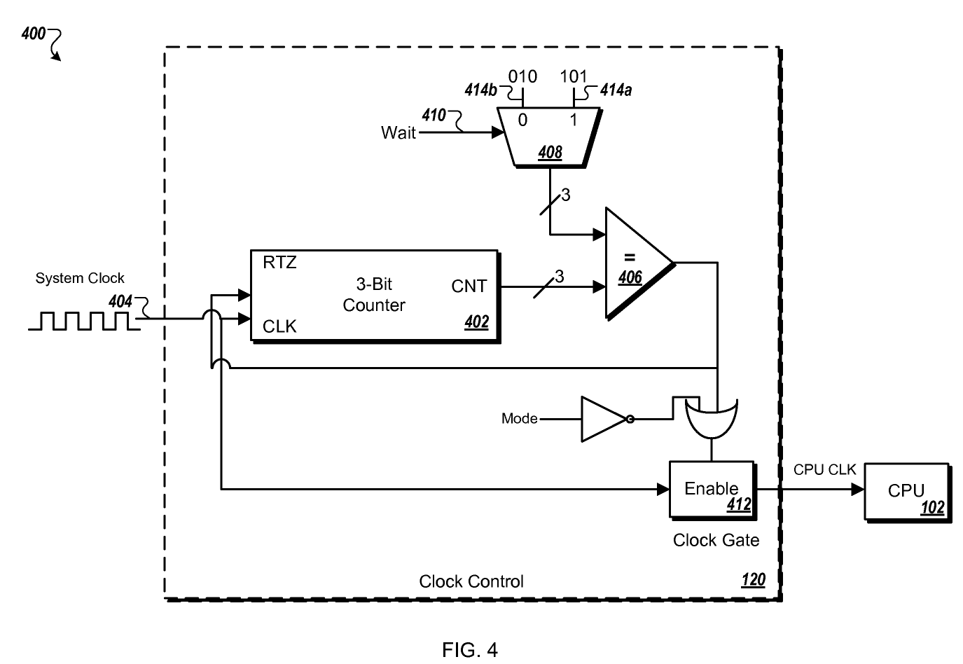

FIG. 4 is a block diagram of an example clock control unit 120 for use within the selectable timing adjustment module 106 as described in FIG. 1. In some implementations, the clock control unit 120 includes a three-bit counter 402 which accepts a system clock input 404 (e.g., the clock source 104 or the output of the clock divider 124, as described in FIG. 1). The three-bit counter 402 can be used to divide the clock input 404 by three. The three-bit counter 402, for example, can supply the B(I) adjustment as described by equation (2). For a different B(I) adjustment, for example, a different capacity counter can be used (e.g., four-bit counter, five-bit counter, etc).

While operating in compatibility mode, the output of the three-bit counter 402 enters a comparator 406. A three-bit multiplexer 408 is also connected to the comparator 406. The three-bit multiplexer 408 accepts a wait signal 410. The wait signal 410 tells the comparator 406 to compare the 3-bit counter output 402 with multiplexer inputs 414b (010 binary) or 414a (101 binary). Assuming the counter 402 starts at zero, this means the comparator 406 provides an enable pulse to the clock gate 412 every 3 clocks when the wait signal 410 is low (0) and every 6 clocks when the wait signal 410 is high (1). The wait signal 410, for example, can supply the A(I) adjustment as described in equation (2). Each instruction cycle, for example, may include a binary wait state which can trigger an additional delay to the adjusted clock output of the clock control unit 120. In some implementations, the instruction decoder 118 (as shown in FIG. 1) supplies the wait signal 410.

The clock gate 412 provides a clock input to the CPU 102. In some implementations, the clock gate 412 receives an enable signal from the mode input 122 through an inverter in series with an OR gate. In fast mode, the enable signal 410 is high so every clock passes through the clock gate 412. The OR gate forces the output of the comparator 406 to the clock gate 412 high when the mode input 122 is inactive and the mode input 122 is inverted high by the inverter.

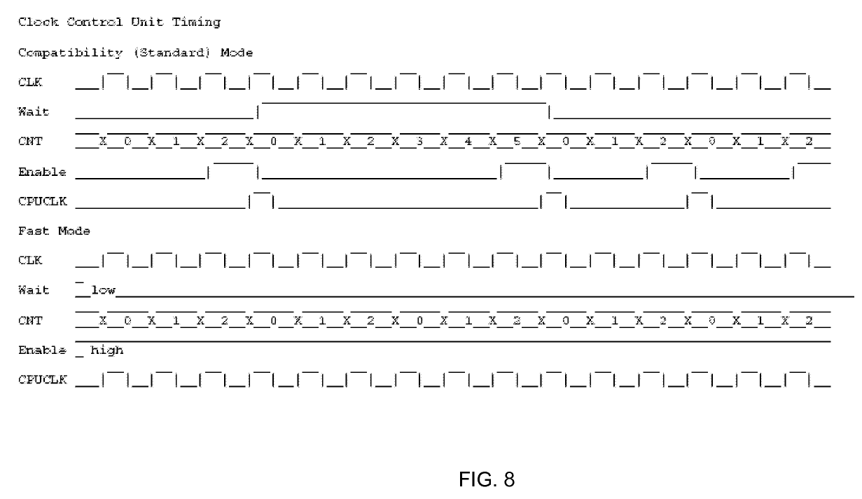

FIG. 8 is a timing diagram for the clock control unit 120 shown in FIG. 4. Timing diagrams for the system clock 404, wait signal 410, counter count, mode enable signal 122 and CPU CLK are shown for compatibility mode and fast mode of the microcontroller.

### Example Timing Adjustments

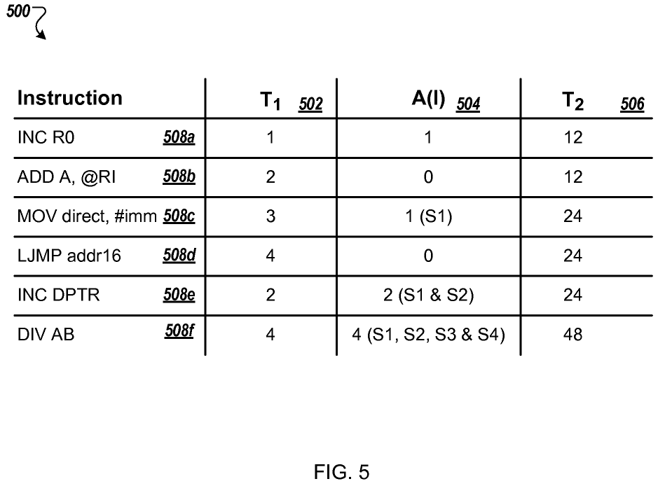

FIG. 5 is a table 500 illustrating timing translations of example instructions performed upon a reduced-cycle microcontroller versus a multiple-cycle microcontroller. The timing translations may be calculated, for example, using equation (2), where in this example B(I) equals three, C(I) equals zero, and D(I) equals two:

T₂(I)=((T₁(I)+A(I))*3+0)*2. (3)

The timing translations, as listed in the table 500, may translate between the reduced-cycle microcontroller instruction execution as illustrated in the timing diagram 300 of FIG. 3 and the multiple-cycle microcontroller instruction execution as illustrated in the timing diagram 200 of FIG. 2.

The table 500 includes a T₁ column 502 which lists the number of clock cycles needed for each example instruction to execute upon a reduced-cycle microcontroller, an A(I) column 504 which lists the number of wait states to inject into the equation (3) to calculate the timing translation, and a T₂ column 506 which lists the number of clock cycles needed for each example instruction to execute upon a multiple-cycle microcontroller. A set of instruction rows 508 list example instructions which may be executed upon either the exemplary reduced-cycle microcontroller or the exemplary multiple-cycle microcontroller. For example, the instructions listed within the instruction rows 508 are provided within the MCS-51™ instruction set (available through Intel Corporation of Santa Clara, Calif.). In some implementations, the decoder 118 (as described in FIG. 1) receives each instruction 508 and calculates the number of wait cycles listed within the A(I) column 504. The decoder 118 triggers the clock control unit 120 during each clock state in which a wait A(I) may be included to complete the calculation of equation (3).

For example, the translation of the INC DPTR instruction 508e from the reduced-cycle microcontroller timing of two clock cycles to the multiple-cycle microcontroller timing of twenty-four clock cycles involves a total of two wait states. The first wait state can be injected into the first clock state (S1) and the second wait state can be injected into the second clock state (S2). In another example, the translation of the MOV direct, #imm instruction 508c from the reduced-cycle microcontroller timing of three clock cycles to the multiple-cycle microcontroller timing of twenty-four clock cycles involves a single wait state. Although within the table 500 the wait state is listed as being injected into the first clock state (S1), in other implementations the first wait state added to an instruction cycle may be inserted into a following clock state of the instruction cycle (e.g., the second clock state (S2) or the third clock state (S3)).

Other instruction translations do not involve the injection of wait states. For example, the ADD A, @R1 instruction 508b does not include a wait state to translate from the two clock cycle reduced-cycle microcontroller timing to the twelve clock cycle multiple-cycle microcontroller timing.

### Example Timing Diagram

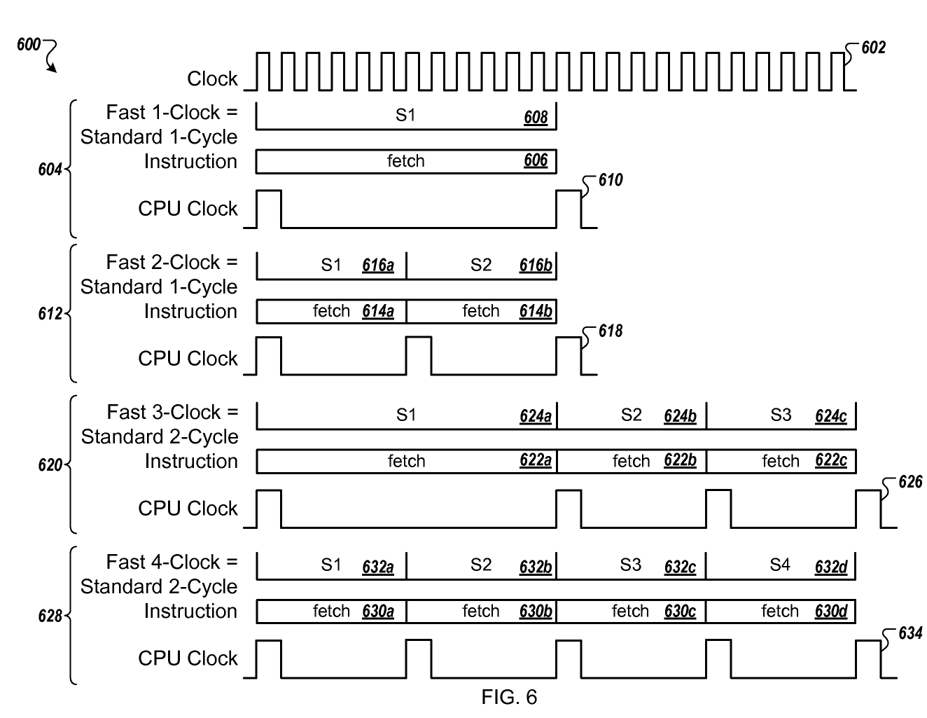

FIG. 6 is a timing diagram 600 illustrating the performance of instructions executed upon a reduced-cycle microcontroller operating within a multiple-cycle microcontroller compatibility mode. The timing diagram 600 includes an external clock signal 602 which can be contrasted to the CPU clock output for each exemplary instruction. The instruction timings, for example, can be calculated using the translation equation (3), as described in reference to FIG. 5. In some implementations, the clock signal 602 is the clock source 104 received by the clock controller unit 106, while the CPU clock output is the clock signal provided to the CPU 102 by the clock controller unit 106 (as shown in FIG. 1).

A first instruction 604 illustrates the translation of a one clock cycle instruction as executed upon a reduced-cycle microcontroller. The first exemplary instruction 604, for example, may be the INC R0 instruction 508a as shown in FIG. 5. The translated multiple-cycle microcontroller timing for the first exemplary instruction 604 includes a single instruction fetch 606 executed during a single clock state 608 (S1). The instruction fetch 606 aligns with the first leading edge of a CPU clock signal 610 and ends with the second leading edge of the CPU clock signal 610. The CPU clock signal cycle spans twelve cycles of the external clock signal 602.

A second instruction 612 illustrates the translation of a two clock cycle instruction as executed upon a reduced-cycle microcontroller. The second instruction 612, for example, may be the ADD A, @R1 instruction 508b as shown in FIG. 5. The translated multiple-cycle microcontroller timing for the second instruction 612 includes two instruction fetches 614a and 614b executed during two clock states S1 616a and S2 616b. The instruction fetch 614a aligns with the first leading edge of a CPU clock signal 618 and the second instruction fetch 614b aligns with the second leading edge of the CPU clock signal 618. The cycle of the CPU clock signal 618 spans six clock cycles of the external clock signal 602.

A third instruction 620 illustrates the translation of a three clock cycle instruction as executed upon a reduced-cycle microcontroller. The third instruction 620, for example, may be the MOV direct, #imm instruction 508c as shown in FIG. 5. The translated multiple-cycle microcontroller timing for the third instruction 620 includes three instruction fetches 622a, 622b, and 622c executed during three clock states S1 624a, S2 624b, and S3 624c. The instruction fetch 622a aligns with the first leading edge of a CPU clock signal 626. The first clock cycle of the CPU clock signal 626, and subsequently the first clock state S1, spans twelve cycles of the external clock signal 602. The second instruction fetch 622b and the third instruction fetch 622c each span six cycles of the external clock signal 602. The variable cycle of the CPU clock signal 626 can be generated by an inserted wait state (e.g., an A(I) adjustment as shown in the timing adjustment equation of FIG. 5). As illustrated in the table 500 of FIG. 5 regarding the MOV direct, #imm instruction 508c, a wait state is inserted into the first clock state S1 within the translation from reduced-cycle microcontroller mode and multiple-cycle microcontroller mode.

A fourth instruction 628 illustrates the translation of a four clock cycle instruction as executed upon a reduced-cycle microcontroller. The fourth instruction 628, for example, may be the LJMP addr16 instruction 508d as shown in FIG. 5. The translated multiple-cycle microcontroller timing for the fourth exemplary instruction 628 includes four instruction fetches 630 executed within four clock states 632, each clock state 632 aligning with a cycle of a CPU clock signal 634 spanning six cycles of the external clock signal 602.

Although four instructions are illustrated within the timing diagram 600, other timing patterns are possible. For example, the INC DPTR instruction 508e and the DIV AB instruction 508f include wait states during every clock state (e.g., two and four). Other timing translation equations may produce different variations of timings. For example, the introduction of a C(I) factor may lengthen one or more of the CPU clock signal cycles.

### Example Process

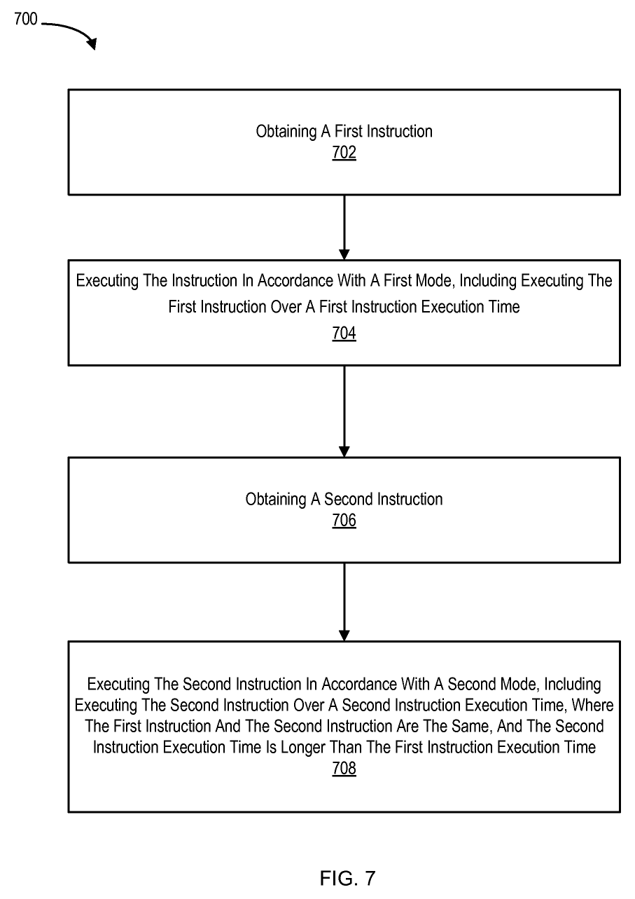

FIG. 7 is a flow diagram of an example microcontroller-implemented process 700 for modifying instruction execution time. In some implementations, the process 700 begins by obtaining a first instruction (702). For example, the first instruction can be obtained from an instruction register (e.g., instruction register 112).

A processor executes the instruction in accordance with a first mode, including executing the first instruction over a first instruction execution time (704). A second instruction is obtained (706). The processor executes the second instruction in accordance with a second mode (e.g., a compatibility mode) over a second instruction execution time. The first instruction and the second instruction are the same instruction and the second instruction execution time is longer than the first instruction execution time (708). For example, in compatibility mode, a clock source for the microcontroller is modified by one or more scale factors and/or wait state factors, resulting in the instruction execution time to be increased so as to be timing compatible with legacy microcontrollers.

While this document contains many specific implementation details, these should not be construed as limitations on the scope what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made. In some implementations, the reduced-cycle microcontroller may include timing options (e.g., a divide-by-two clock feature). The clock adjustment module 106, for example, can include one or more inputs for compatibility with timing options available within the microcontroller 100 (as shown in FIG. 1). In another example, steps of one or more processes may be combined, deleted, modified, or supplemented to form further processes. As yet another example, the process steps depicted in the figures do not require the particular order shown to achieve desirable results. In addition, other steps may be provided, or steps may be eliminated, from the described processes, and other materials may be added to, or removed from, the described processes. Accordingly, other implementations are within the scope of the following claims.

What is claimed is:

1. A microcontroller-implemented method, comprising:
determining a mode of a microcontroller; and
if the mode is a compatibility mode, modifying a clock source of the microcontroller to increase instruction execution time.

2. The method of claim 1, where modifying further comprises:
selecting one or more scaling factors or wait state factors; and
applying the one or more scaling factors or wait state factors to the clock source.

3. The method of claim 1, where the one or more scale factors or wait state factors are functions of a current instruction.

4. The method of claim 1, where the one or more scale factors or wait state factors are a constant value.

5. The method of claim 1, where the one or more scale factors or wait state factors are based on an architecture of the microcontroller.

6. The method of claim 1, where the instruction execution time is increased based on the formula T₂(I)=T₁(I)*S(I)+W(I), where T₁ is an instruction execution time for a first microcontroller mode and T₂ is an instruction execution time for a second microcontroller mode, I is a current instruction, and S(I) is a scale factor and W(I) is a wait cycle associated with the instruction I.

7. The method of claim 1, where the instruction execution time is increased based on the formula T₂(I)=((T₁(I)+A(I))*B(I)+C(I))*D, where T₁ is an instruction execution time for a first microcontroller mode and T₂ is an instruction execution time for a second microcontroller mode, I is a current instruction, D is a divider adjustment representing a quantity adjustment provided by a clock divider, A(I) represents a number of wait states, each wait state scaled by a wait scaling factor B(I) or the divider adjustment D, and C(I) is a further adjustment.

8. The method of claim 7, further comprising:
prescaling the clock source by the factor D prior to modifying the clock source.

9. The method of claim 1, where modifying instruction execution time includes gating or dividing the clock source.

10. A microcontroller-implemented method, comprising:
obtaining a first instruction;
executing the instruction in accordance with a first mode, including executing the first instruction over a first instruction execution time;
obtaining a second instruction; and
executing the second instruction in accordance with a second mode, including executing the second instruction over a second instruction execution time, where the first instruction and the second instruction are the same, and the second instruction execution time is longer than the first instruction execution time.

11. The method of claim 10, where executing the second instruction in accordance with a second mode includes gating or dividing a clock source.

12. The method of claim 10, where executing the second instruction in accordance with a second mode comprises:
selecting one or more scaling factors or wait state factors; and
applying the one or more scaling factors or wait state factors to a clock source of the microcontroller.

13. The method of claim 10, where the one or more scale factors or wait state factors are functions of a current instruction.

14. The method of claim 10, where the one or more scale factors or wait state factors are a constant value.

15. The method of claim 10, where the one or more scale factors or wait state factors are based on an architecture of the microcontroller.

16. The method of claim 10, where the second instruction execution time is increased from the first instruction execution time based on the formula T₂(I)=T₁(I)*S(I)+W(I), where T₁ is the first instruction execution time for the first mode and T₂ is a second instruction execution time for the second mode, I is a current instruction, and S(I) is a scale factor and W(I) is a wait cycle associated with the instruction I.

17. The method of claim 10, where the second instruction execution time is increased based on the formula T₂(I)=((T₁(I)+A(I))*B(I)+C(I))*D, where T₁ is the first instruction execution time for the first mode and T₂ is the second instruction execution time for the second mode, I is a current instruction, D is a divider adjustment representing a quantity adjustment provided by a clock source divider, A(I) represents a number of wait states, each wait state scaled by a wait scaling factor B(I) or the divider adjustment D, and C(I) is a further adjustment.

18. A microcontroller with compatibility mode, comprising:
an instruction register operable for storing an instruction;
a clock control operable for modifying a clock source if the microcontroller is in compatibility mode; and
a processor operable for executing the instruction using the modified clock source.

19. The microcontroller of claim 18, if the microcontroller is not in compatibility mode, the processor is operable for executing the instruction using an unmodified clock source.

20. The microcontroller of claim 18, further comprising:
a clock divider operable for dividing the clock source prior to the clock control modifying the clock source.

21. The microcontroller of claim 18, further comprising:
a mode selector operable for selecting compatibility mode.

22. The microcontroller of claim 18, where the clock control includes a finite state machine that is operable to modify the clock source using clock division or clock gating to increase execution time of the instruction.

23. The microcontroller of claim 18, further comprising:
a decoder operable for providing values of instruction dependent factors used to modify the execution time of the instruction.

24. The microcontroller of claim 23, where the execution time of the instruction is increased based on the formula T₂(I)=T₁(I)*S(I)+W(I), where T₁ is a first instruction execution time for standard mode and T₂ is a second instruction execution time for compatibility mode, I is a current instruction, and S(I) and W(I) are the instruction dependent factors.

25. The microcontroller of claim 23, where the execution time of the instruction is increased based on the formula T₂(I)=((T₁(I)+A(I))*B(I)+C(I))*D, where T₁ is a first instruction execution time for standard mode and T₂ is the second instruction execution time for compatibility mode, I is a current instruction, D is a divider adjustment representing a quantity adjustment provided by a clock source divider, A(I) represents a number of wait states, each wait state scaled by a wait scaling factor B(I) or the divider adjustment D, and C(I) is a further adjustment.
